(19) United States
(12) Patent Application Publication
(10) Pub. No.: US 2006/0150485 A1
(43) Pub. Date: Jul. 13, 2006

(54) Garden extrusion

(76) Inventor: Declan Somerville, South Australia (AU)

Correspondence Address: O M Sam Zaghmout;Bio Ips, 8509 Kernon Ct., Lorton, VA, 22079, US

(21) Appl. No.: 10/536,865

(22) PCT Filed: Dec. 1, 2003
(86) PCT No.: PCT/AU03/01595

§ 371 Date: Nov. 21, 2005

(30) Foreign Application Priority Data
Nov. 29, 2002 (AU) 2002952991

(51) Int. Cl. A01G 9/12; A01G 17/14

(52) U.S. Cl. 47/47; 248/530

(57) ABSTRACT

An extrusion (10) including a central wall portion (12) and a surrounding perimeter portion (14, 18) whereby the central wall portion (12) divides the extrusion (10) into opposing chambers, said perimeter portion (14, 18) having a respective opening therein into each of said chambers and each said chamber being able to have a perimeter portion (14, 18) of a further extrusion (10) locked thereinto to form an interlocked unit.

### FIELD OF THE INVENTION

The present invention relates to a garden extrusion. The extrusion of the invention is particularly useful as a garden stake.

### BACKGROUND OF THE INVENTION

Garden stakes come in many and varied sizes. Gardeners will typically select a stake from a range of available materials to suit the intended ground and any plants to be supported by the stake. For example stronger, heavier, thicker stakes might be used where the ground is hard, or there are large shrubs or trees to be supported. Similarly in softer ground or for more delicate plants a less substantial stake might be selected.

The present invention relates to an extrusion from which stakes may be constructed according to need to thereby satisfy the above requirement.

### SUMMARY OF THE INVENTION

Therefore according to a first aspect of the present invention there is provided an extrusion characterized in that it includes a central wall portion and a surrounding perimeter portion, whereby the central wall divides the extrusion into opposing chambers said perimeter portion having a respective opening therein into each of said chambers and each said chamber being able to have a perimeter portion of a further extrusion locked thereinto to form an interlocked unit.

Preferably, the extrusion is generally rectangular in shape and the closed sides are, in outer dimension, shorter than the open sides. More preferably still, the outer dimension of the closed sides, from edge to edge corresponds to the inner distance of an open side in the chamber. Similarly, the length of the edges of the open sides corresponds to the distance between the central wall and the inner wall of the edges.

Preferably, it is possible to interlock two extrusion elements inserting the closed side one extrusion into a chamber of a second extrusion forming a stable structure.

Thus, in a second form of the invention there is provided an assembly composed of two interlocked extrusions formed by inserting a closed side of a first extrusion through the opening into a chamber of a second extrusion whereby the closed side of the first extrusion lies against the central wall of the second extrusion and the edge portions of the open sides of the first extrusion are then locked into engagement with the second extrusion by virtue of the fact that they are located in the chamber thereof and lie against the inner side of the wall of the second extrusion and between the central wall and an inner surface of edge portion of the second extrusion.

### DESCRIPTION OF DRAWINGS

FIG. 1 illustrates in perspective view an extrusion in accordance with the present invention; and

FIG. 2 illustrates is cross-sectional view an interlocking arrangement of extrusions formed in accordance with the invention.

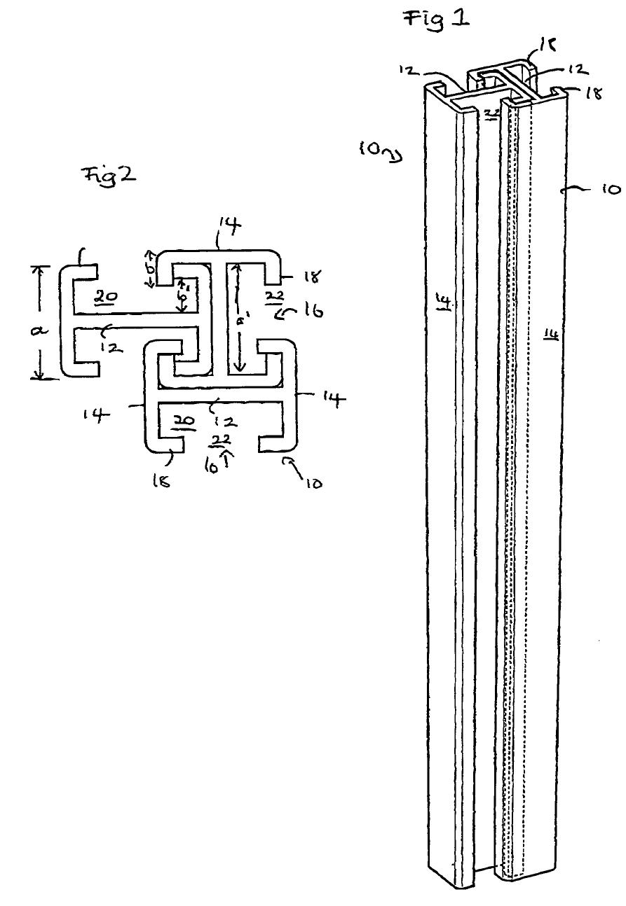

The above and other objects, features, and advantages of the present invention will be apparent from the following detailed description of a preferred embodiment in conjunction with the accompanying drawings.

### DESCRIPTION OF THE PREFERRED EMBODIMENT

Shown in the drawings are interlocking extrusions 10 that may be used either singly or in combination form. The extrusions as illustrated are for use in a garden stake, however, the extrusion of the invention has a more general applicability and the invention should not be read down as being restricted to garden stakes.

Each interconnecting extrusion 10 consists of an extrusion that in cross section takes the form of a back to back C-shaped element. The extrusion thus has a central wall 12 that is the back to back element of the C shape and outer sides 14 perpendicular thereto. The central wall 12 effectively intersects the side walls 14 midway between ends thereof. The side walls 14 are that are closed and lead to open sides 16. The open sides 16 consist of edge portions 18 on either side of an opening 22. As can be seen from the drawings the openings 22 face the central wall 12. The central wall 12 thus, divides the extrusion 10 into two opposing chambers 20, the chambers 20 each being defined by the wall 12, a portion of each of the closed side walls 14 and an open sides 16 including two edge portions 18 and the opening 22 therebetween.

It can also be seen that the extrusion has a central wall 12 bound by a perimeter comprised of the two opposing longer open sides and the shorter closed sides.

The extrusions 10 are generally rectangular in cross-sectional outline and dose examination of the cross-sectional views shows that the closed sides 14 are, in outer dimension, shorter than the open sides 16. Further, it can be seen that the outer dimension of the closed sides 14, from outer edge to outer edge, as shown at a in the drawings corresponds to the inner distance of an open side shown at a′. The closed side wall 14 thus has external dimensions that correspond to the length of the central wall 12. Still further it can be seen that the length of the edge portions 18 of the open sides 16 as shown at b corresponds to the distance between the central wall 12 and the inner surface of the edges 18, indicated at b′.

Thus, in use, it is possible to interlock two extrusion elements 10 as shown in FIG. 2 by inserting the closed side 14 one extrusion through the opening 22 into a chamber 20 of a second extrusion 10. The close correspondence of the dimensions as described ensures a close fit between the two interlocked portions thereby forming a stable structure. Specifically, as can be seen in the drawings, the closed side 14 of a first extrusion 10 lies against the central wall 12 of a second extrusion 10. The edge portions 18 of the first extrusion 10 are then locked into engagement with the second extrusion by virtue of the fact that they are located in the chamber 20 and lie against the inner side of the wall 14 of the second extrusion and between the central wall 12 and an inner surface of edge portion 18 of the second extrusion.

The extrusion of the invention therefore allows for rapid and secure connections to be made between two or more such extrusions in spite of the relative simplicity of the design. Further, any assembly made between extrusion is rapidly disassembles as required.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to be details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. An extrusion characterized in that it includes a central wall portion and a surrounding perimeter portion, whereby the central wall divides the extrusion into opposing chambers said perimeter portion having a respective opening therein into each of said chambers and each said chamber being able to have a perimeter portion of a further extrusion locked thereinto to form an interlocked unit.

2. An extrusion according to claim 1, characterized in that the perimeter of the extrusion is generally rectangular having opposing pairs of longer and shorter sides, wherein said openings into said chambers are provided in opposing longer sides.

3. An extrusion according to claim 2, characterized in that the central wall divides the extrusion into two chambers of equal dimension.

4. An extrusion according to claim 2, characterized in that the closed side wall has external dimensions that correspond to the length of the central wall.

5. An extrusion according to claim 2, characterized in that the external length of edges of the open, longer sides corresponds to the distance between the central wall and the inner surface of the longer sides.

6. An assembly composed of two interlocked extrusions according to any one of claims 1-5, formed by inserting a closed side of a first extrusion through the opening into a chamber of a second extrusion whereby the closed side of the first extrusion lies against the central wall of the second extrusion and the edge portions of the open sides of the first extrusion are then locked into engagement with the second extrusion by virtue of the fact that they are located in the chamber thereof and lie against the inner side of the wall of the second extrusion and between the central wall and an inner surface of edge portion of the second extrusion.
